(19) United States
(12) Patent Application Publication
(10) Pub. No.: US 2021/0368105 A1
(43) Pub. Date: Nov. 25, 2021

(54) VIDEO CAPTURE DEVICE POSITIONING BASED ON PARTICIPANT MOVEMENT

(71) Applicant: HEWLETT-PACKARD DEVELOPMENT COMPANY, L.P., Spring, TX (US)

(72) Inventors: Mithra Vankipuram, Palo Alto, CA (US); Kevin Smathers, Palo Alto, CA (US); Hiroshi Horii, Palo Alto, CA (US)

(73) Assignee: HEWLETT-PACKARD DEVELOPMENT COMPANY, L.P., Spring, TX (US)

(21) Appl. No.: 17/052,138

(22) PCT Filed: Oct. 18, 2018
(86) PCT No.: PCT/US2018/056558

§ 371 Date: Oct. 30, 2020

(51) Int. Cl. H04N 5/232; G02B 27/01; G02B 27/00; G06N 20/00; G06K 9/00; H04W 4/029

(52) U.S. Cl. CPC H04N 5/23299; G02B 27/017; G02B 27/0093; G06N 20/00; G02B 2027/0138; G06K 9/00315; H04N 5/23216; H04W 4/029; H04N 5/23296

(57) ABSTRACT

A system includes a video capture device to broadcast an image of a streaming participant. A motion platform moves the video capture device in response to a control command. A controller receives location data associated with the participant. The controller positions the video capture device such that the participant's location within the image is adjusted by the control command. The control command is adjusted according to participant movement detected by changes in the location data.

### BACKGROUND

Virtual reality (VR) is an interactive computer-generated experience within a simulated environment that incorporates mainly auditory and visual feedback, but also other types of sensory feedback. This immersive environment can be similar to the real world or it can be based on alternative happenings, thus creating an experience that is not possible in ordinary physical reality. Augmented reality systems may also be considered a form of VR that layers virtual information over a live camera feed into a headset or through a smartphone or tablet device giving the user the ability to view three-dimensional images. Current VR technology most commonly uses virtual reality headsets or multi-projected environments, sometimes in combination with physical environments or props, to generate realistic images, sounds and other sensations that simulate a user's physical presence in a virtual or imaginary environment.

### BRIEF DESCRIPTION OF THE DRAWINGS

FIG. 1 illustrates an example of a system to control a video capture device based on participant movement.

FIG. 2 illustrates an example of a system that receives coordinates from a virtual reality headset to track participant movement and control a video capture device based on the participant movement.

FIG. 3 illustrates an example of a system that utilizes a machine learning detector to track participant movement and control a video capture device based on the participant movement.

FIG. 4 illustrates an example of a system that utilizes an infrared sensing to track participant movement and control a video capture device based on the participant movement.

FIG. 5 illustrates an example of a system that employs an expression detector to control a zoom lens of a video capture device based on a participant's expression.

FIG. 6 illustrates an example of a device to control a participant's positioning within a video stream based on detected participant movement.

FIG. 7 illustrates an example of a method to control a participant's positioning within a video stream based on detected participant movement.

### DETAILED DESCRIPTION

This disclosure relates to streaming images of a participant in a given application to outside audience members that are viewing the participant. As the images are generated and the participant moves according to what is happening in the application, a video capture device such as a camera is automatically adjusted to reposition the camera such that the participant remains in the field of view of the camera and thus can be properly observed by the audience members. The application may be a virtual reality (VR) application where images of a VR participant are monitored and streamed to audience members (e.g., over the Internet) who view the reaction of the VR participant to the respective VR application.

In one example, a system is provided that includes a video capture device (e.g., camera) to broadcast an image of a streaming participant such as a participant in the VR application. A motion platform (e.g., pan, tilt, zoom platform) moves the video capture device in response to a control command. A controller receives location data associated with the participant (e.g., from a VR headset). The controller positions the video capture device such that the participant's location within the streamed image is adjusted by the control command. The control command can be adjusted according to participant movement detected by changes in the location data associated with the participant. In this manner, if the participant moves during a given application, the video capture device can be automatically repositioned based on the location data to provide images of the participant within the field of view of the device. In one example, the participant can be centered within the field of view or positioned within a predetermined area of the image (e.g., at the top or bottom of the image captured within the field of view). A location detector can be provided to determine location data from the participant. In one example, the location detector is provided from a VR headset where coordinates of the participant's location are transmitted as the location data to the controller. In another example, machine learning can be utilized for object detection to recognize the VR headset and thus provide the location data to the controller. In yet another example, sensors such as infrared sensor can be mounted on the headset and tracked to provide the location data to the controller.

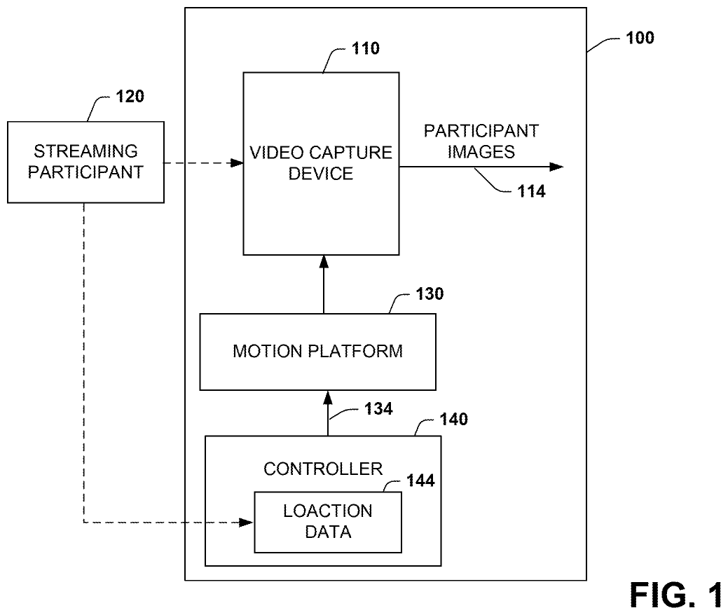

FIG. 1 illustrates an example of a system 100 to control a video capture device 110 based on participant movement. As shown, the system 100 includes the video capture device 110 to broadcast an image (or images) 114 of a streaming participant 120. In one example, the streaming participant 120 can be a virtual reality participant but substantially any type of video streaming application can be supported where the participant desires to broadcast their activities to audience members over a network (e.g., public network such as Internet or close circuit network). The video capture device 110 can be a camera in one example or a sensor such as a charge coupled device (CCD) or other semiconductor sensor that is monitored by a processor (not shown) to capture a sequence of images from the streaming participant 120. A motion platform 130 moves the video capture device 110 in response to a control command 134. A controller 140 receives location data 144 associated with the participant. The controller 140 positions the video capture device 110 such that the participant's location within the image 114 is adjusted by the control command 134. The control command 134 can be adjusted according to participant movement detected by changes in the location data 144.

In an example streaming application, current virtual reality (VR) systems allow streaming images of participants of VR applications. The images broadcast the participant's reactions to a given application by a video capture device such as a camera to outside audience members who may be viewing over the Internet, for example. Based on participant reactions however, such as movement of the VR participant within a given scene of the VR application, this can cause the participant to move off camera and thus prevent the audience from seeing a given reaction. The system 100 automatically detects movement of the streaming participant 120 and automatically reorients the video capture device 110 based on participant movement. In this manner, even if the streaming participant 120 physically moves their location based on a reaction to a given application, the location data can 144 reflect such movement and thus allow the controller 140 to reposition the motion platform 130 such that the participant remains within the field of view of video capture device 110.

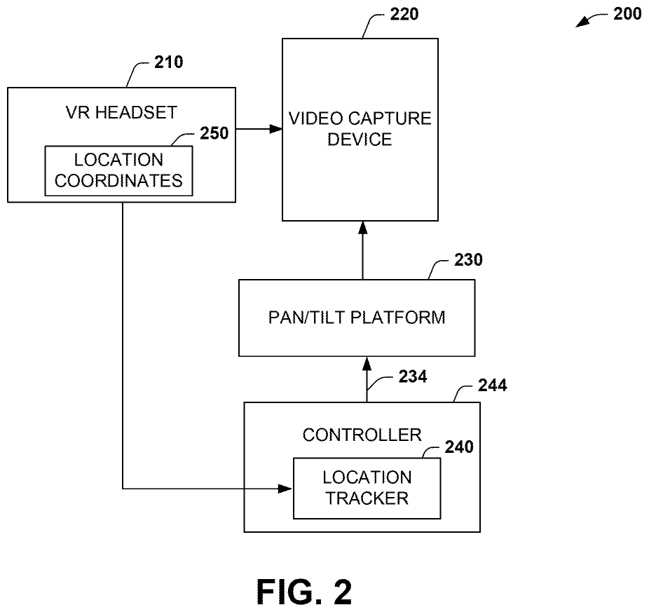

The system 100 automatically moves the video capture device 110 to capture movements of the participant 120 in a given streaming application such as an immersive virtual reality (VR) application. In contrast to a fixed camera position for current applications where the streaming participant 120 may be off the frame or to the far left of right, the system 100 can automatically reorient the participant within the broadcast images 114 based on detected participant movement. This can include centering the participant within the image or images 114 or placing the participant in a predetermined location of the images such as at the top or bottom of the image 114. In one example, a virtual reality headset (see e.g., FIGS. 2-5) can be tracked to determine the location data 144. By tracking the headset, the system 100 facilitates that the active VR participant is centered (or some other orientation within the video frame) during video capture.

Various video processing methods and devices can be provided to track the headset which are described below. In one example, the headset can be tracked using object detection and tracking where machine learning can be trained to recognize the headset as an object. Active motion tracking is provided in case the user turns thereby occluding the headset from the video capture device 110. In another example, coordinates can be provided from VR systems that track VR controllers in the headset. The VR system can provide feedback regarding where the pan/tilt/zoom camera is and can transform three-dimensional (3D) coordinates of headset into the 2D reference point for the camera view. Depending on this information, the camera can pan, tilt, or zoom as needed. In yet another example, infrared sensing can be provided where the head set is equipped with an infrared emitter. The pan tilt zoom camera (or motion platform) can be equipped with an IR sensor. The camera is then adjusted by a controller to facilitate that beacons transmitted from the headset are centered in its frame. Other parameters can be provided to the controller 140. These parameters can include when a headset is put on and taken off, for example. This game state information (e.g., such as application running or ended) can be sent over to the controller 140 to control video capture and device movements. Also, information about headset height from the ground can be used as another signal to indicate when to track the streaming participant 120 (e.g., participant moves from a standing to a seated position).

FIG. 2 illustrates an example of a system 200 that receives coordinates from a virtual reality headset 210 to track participant movement and control a video capture device 220 based on the participant movement. The system 200 includes a video capture device 220 to broadcast an image of a streaming participant. A pan/tilt platform 230 moves the video capture device 220 in response to a control command 234. A location tracker 240 determines location data received from the headset 210 of the VR participant. A controller 244 receives location data from the location tracker 240 and positions the video capture device 220 such that the participant's location within the image is adjusted by the control command 234. As described previously, the control command 234 can be adjusted according to participant movement detected by changes in the location data.

In this example, the location data is provided as location coordinates 250 from the VR headset 210 to the location tracker 240. The location coordinates 250 are translated from virtual coordinates of the VR headset 210 to a reference point of the video capture device 220 by the location tracker 240 to provide physical coordinates for movement of the pan/tilt platform 230. For example, the reference point can be set as a point in space where the user is centered in the broadcast image which can be set as a given height and yaw position of the video capture device 220 to center the participant such as when they are seated in and before application movements have begun.

The location coordinates 250 which may be virtual coordinates associated with a virtual video frame of the application can be translated to physical coordinates to position the video capture device 220 such that the participant is centered (or some other predetermined orientation) within the physical frame produced by the video capture device. For instance, the physical coordinates determined by the location tracker 240 can be translated to the control command 234 as a pitch command that controls up and down movement or rotation of the pan/tilt platform 230 and a yaw command that controls side-to-side movement or rotation of the platform which has the effect of positioning the participant within a desired area of the video stream produced by the video capture device 220.

In another example, the pan/tilt platform 230 can be mounted on another movable axis (not shown) to control physical repositioning of the motion platform. For example, lateral (e.g., front-to-back, side-to-side) and/or up/down movement of the platform can be achieved in response to the control command 234 or a separate repositioning command sent to the movable axis. Thus, if the participant were to move greater than a predetermined distance from a given starting point, the movable axis can reposition the pan/tilt platform 230 in response to the control command 230 (or another repositioning command for the movable axis) such that the participant remains within the field of view of the video capture device 220.

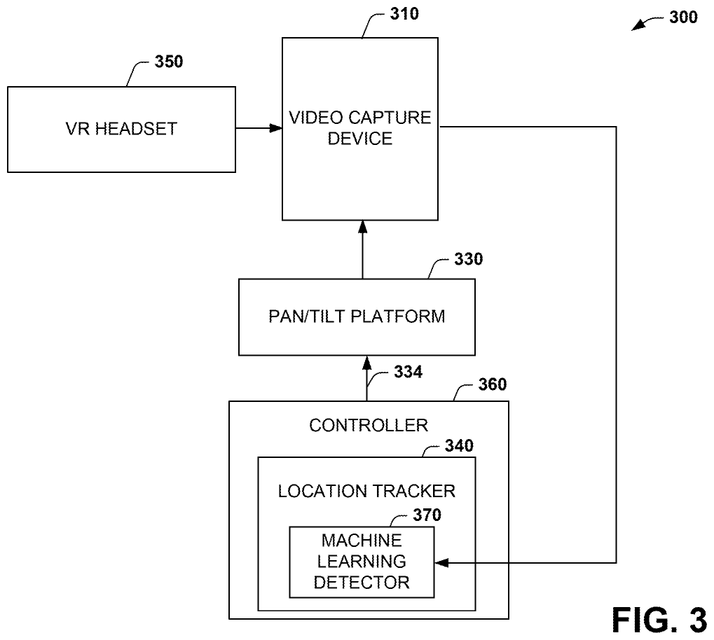

FIG. 3 illustrates an example of a system 300 that utilizes a machine learning detector 304 to track participant movement and control a video capture device 310 based on the participant movement. Similar to the systems previously described, the system 300 includes a video capture device 310 to broadcast an image of a streaming participant. A pan/tilt platform 330 moves the video capture device 310 in response to a control command 334. A location tracker 340 determines location data based on a headset 350 of the VR participant. A controller 360 receives location data from the location tracker 340 and positions the video capture device 310 such that the participant's location within the image is adjusted by the control command 334. As described previously, the control command 334 is adjusted according to participant movement detected by changes in the location data.

In this example, the location tracker 340 a machine learning detector 370 that learns the shape of the VR headset 350 during a training sequence and generates the location data by detecting movement of shape within images captured by the video capture device 310. The machine learning detector can include substantially any type of learning to determine the shape of the head set 350 and thus, determine when the shape has moved to another position within a given image frame captured by the video capture device 310. In one example, the machine learning detector 370 can be implemented as a classifier to determine the shape and subsequent movements of the headset 350. An example of a classifier is a support vector machine (SVM) but other types of classifiers can be implemented.

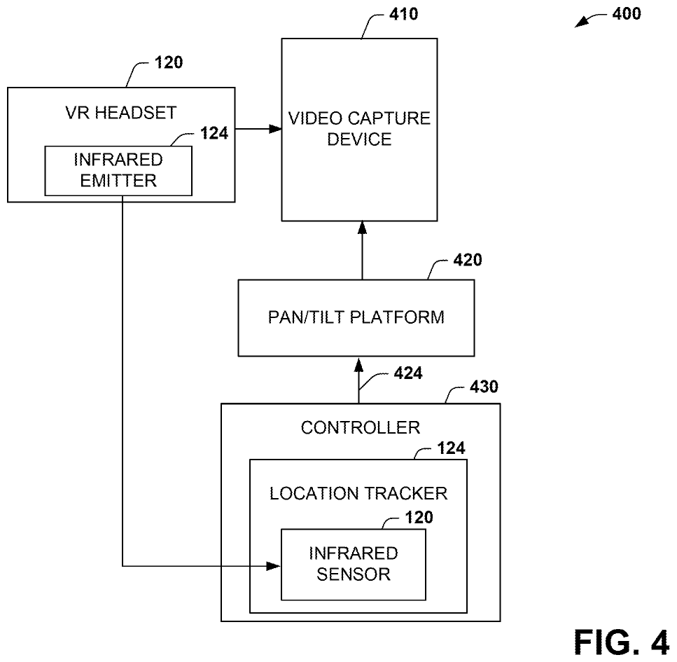

FIG. 4 illustrates an example of a system 400 that utilizes an infrared sensing to track participant movement and control a video capture device 410 based on the participant movement. Similar to the systems previously described, a pan/tilt platform 420 is provided to control movement of the video capture device 410 in response to a control command 424. A controller 430 generates the control command 424 and controls movement of the pan/tilt platform 420 based on location data provided by a location tracker 440 which tracks movement of a VR headset 450. In this example, the location tracker 440 includes an infrared sensor 450 to detect an infrared beacon generated from an infrared emitter 460 in the VR headset 450.

The location data from the location tracker 440 provides an alignment parameter to the controller 440 to center the VR headset 450 within a field of view of the video capture device 410. For example, during an initial alignment of the VR headset 450, the beacon provided by the infrared emitter 460 can be used to center the video capture device on the participant. As the VR headset moves during a given stream application, movement of the beacon can be tracked by the infrared sensor 450 to cause subsequent adjustment of the pant/tilt platform 420 in response to the control command 424. Beacon movement can be tracked by monitoring movement of the beacon across the sensor 450 or by detecting signal strength of the beacon where maximum received strength, for example, indicates centering of the beacon.

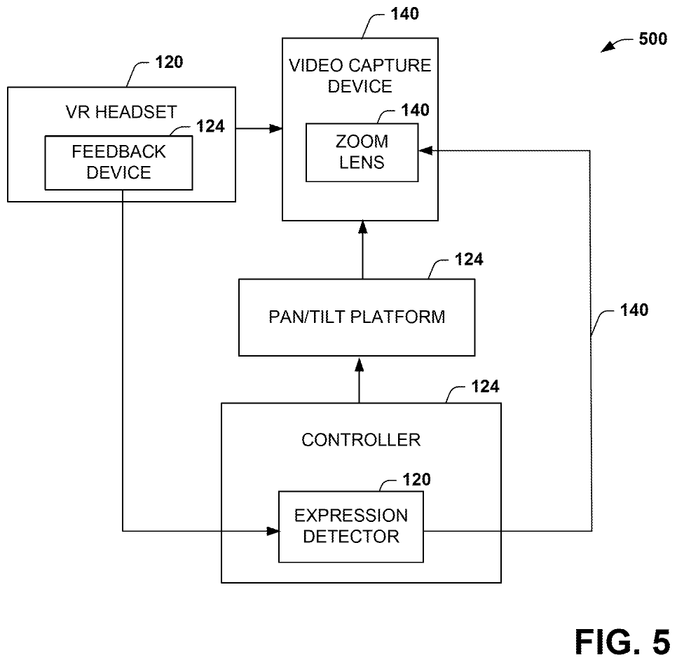

FIG. 5 illustrates an example of a system 500 that employs an expression detector 510 to control a zoom lens 520 of a video capture device 530 based on a participant's expression. A feedback device 540 can be mounted on a VR headset 550 to provide data regarding a participant's expression. In another example, the feedback device 540 can be mounted on the user and in proximity of the headset 550. The expression detector 510 receives feedback data 560 from the feedback device 540 to determine the participant's expression. Based on the determined expression (e.g., surprise, shock, happiness, sadness, confusion, and so forth), the expression detector 510 can adjust the zoom lens 520 to capture a given expression. For example, if a participant has a heighted emotional response by a given scene of an application, the expression detector 510 can send a zoom command 564 to cause the zoom lens 520 to zoom in on the participant and to thus convey the expression to audience members who are viewing the respective video stream from the video capture device 530. Also, a controller 570 can adjust a pan/tilt platform 580 based on given movements of the participant in addition to capturing the expression.

The expression detector 510 can be configured detect a change of expression of the participant (based on a probability threshold), where the zoom command 564 can be adjusted based on the detected change of expression. In one example, the feedback device 540 can include a manual control to allow the participant to snapshot an image of the participant's current expression. In another example, the feedback device can include a muscle sensor worn by the participant to detect the change in expression. In yet another example, the feedback device 540 can include an audible sensor to detect a change in voice inflection of the participant.

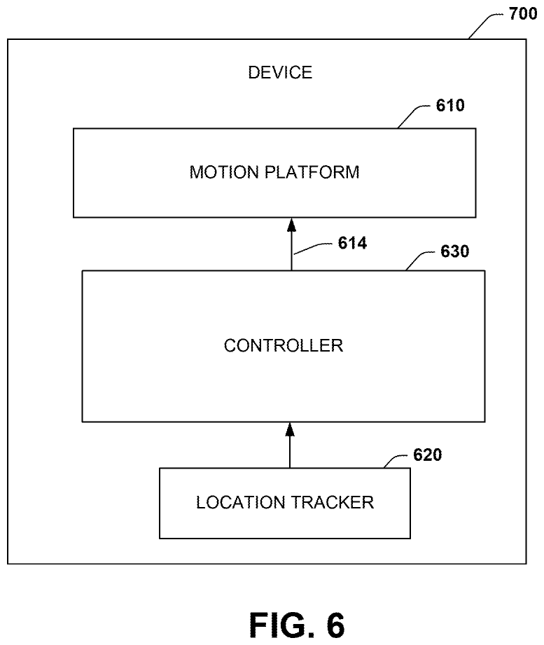

FIG. 6 illustrates an example of a device 600 to control a participant's positioning within a video stream based on detected participant movement. The device 600 includes a motion platform 610 including a camera (not shown) mounted thereon to generate an image of a virtual reality (VR) participant. The motion platform 610 moves the camera in response to a control command 614. A location tracker 620 determines location data received from a headset of the VR participant. A controller 630 positions the motion platform 610 such that the VR participant's location within the image is adjusted by the control command 614 in response to physical changes of the headset as determined from the location data.

As described previously, the location data can be provided as location coordinates from the headset to the location tracker 620. The location coordinates are translated from virtual coordinates of the headset to a reference point of the camera by the location tracker to provide physical coordinates for movement of the motion platform 630. In another example, the location tracker 620 can include an infrared sensor to detect an infrared beacon generated from an infrared emitter in the headset, where the location data from the location tracker provides an alignment parameter to the controller 630 to center the headset within a field of view of the camera.

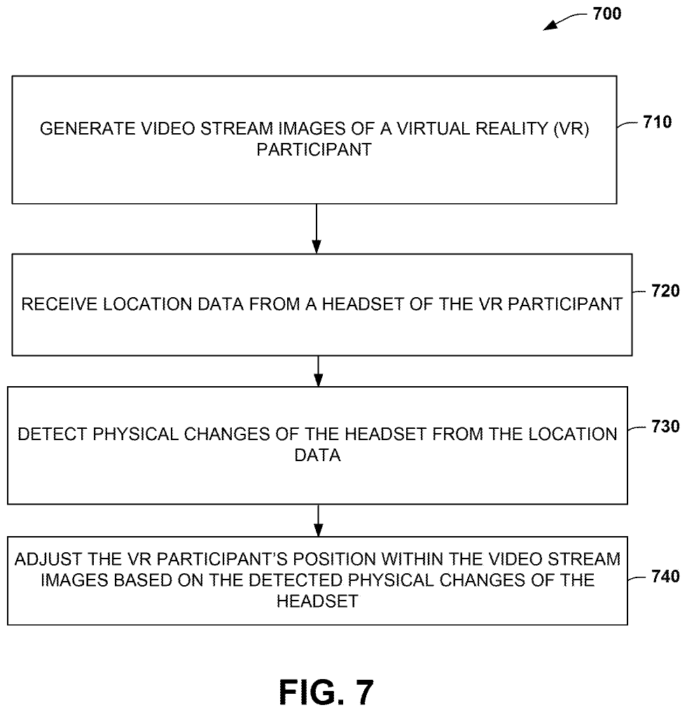

In view of the foregoing structural and functional features described above, an example method will be better appreciated with reference to FIG. 7. While, for purposes of simplicity of explanation, the method is shown and described as executing serially, it is to be understood and appreciated that the method is not limited by the illustrated order, as parts of the method could occur in different orders and/or concurrently from that shown and described herein. Such method can be executed by various components configured as machine-readable instructions stored in a non-transitory media and executable by a processor (or processors), for example.

FIG. 7 illustrates a method 700 to control a participant's positioning within a video stream based on detected participant movement. At 710, the method 700 includes generating video stream images of a virtual reality (VR) participant. At 720, the method 700 includes receiving location data from a headset of the VR participant. At 730, the method 700 includes detecting physical changes of the headset from the location data. At 740, the method 700 includes adjusting the VR participant's position within the video stream images based on the detected physical changes of the headset. Although not shown, the method 700 can also include selecting between a plurality of cameras for generating the video stream images of the virtual reality (VR) participant based on detecting physical changes of the headset. For example, if the participant turned completely around during an application and thus, may no longer be facing a given camera, this may prevent a single camera from capturing the participant's face along with any emotion being expressed. Thus, by providing multiple cameras and selecting the camera the participant is now facing based on headset movement, this would allow the participant to remain in the field of view of at least one of the plurality of cameras.

What has been described above are examples. One of ordinary skill in the art will recognize that many further combinations and permutations are possible. Accordingly, this disclosure is intended to embrace all such alterations, modifications, and variations that fall within the scope of this application, including the appended claims. Additionally, where the disclosure or claims recite “a,” “an,” “a first,” or “another” element, or the equivalent thereof, it should be interpreted to include one such element and neither requiring nor excluding two or more such elements. As used herein, the term “includes” means includes but not limited to, and the term “including” means including but not limited to. The term “based on” means based at least in part on.

What is claimed is:

1. A system, comprising:
a video capture device to broadcast an image of a streaming participant;
a motion platform to move the video capture device in response to a control command; and
a controller to receive location data associated with the participant, the controller to position the video capture device such that the participant's location within the image is adjusted by the control command, the control command adjusted according to participant movement detected by changes in the location data.

2. The system of claim 1, further comprising a location tracker to determine location data from a virtual reality (VR) headset of the participant.

3. The system of claim 2, wherein the location data is received as location coordinates from the VR headset by the location tracker, the location coordinates are translated by the location tracker from virtual coordinates of the VR headset to a reference point of the video capture device to provide physical coordinates to the controller for movement of the motion platform.

4. The system of claim 3, wherein the physical coordinates are translated by the location tracker to the control command as a pitch command that controls up and down movement or rotation of the motion platform, a yaw command that controls side-to-side movement or rotation of the motion platform, or a reposition command that controls physical repositioning of the motion platform.

5. The system of claim 2, wherein the location tracker further comprises a machine learning detector that learns the shape of the VR headset during a training sequence and generates the location data by detecting movement of shape within images captured by the video capture device.

6. The system of claim 2, wherein the location tracker further comprises an infrared sensor to detect an infrared beacon generated from an infrared emitter in the VR headset, wherein the location data from the location tracker provides an alignment parameter to the controller to center the VR headset within a field of view of the video capture device.

7. The system of claim 1, wherein the video capture device includes a lens having a zoom control to adjust the distance of the lens relative to the participant in response to a zoom command from the controller.

8. The system of claim 7, further comprising an expression detector to detect a change of expression of the participant, wherein the zoom command is adjusted based on the detected change of expression.

9. The system of claim 8, further comprising a feedback device to receive expression data from the participant, the feedback device includes a manual control to snapshot an image of the participant's current expression, a muscle sensor worn by the participant to detect the change in expression, or an audible sensor to detect a change in voice inflection of the participant.

10. The system of claim 1, wherein the motion platform is a pan/tilt platform that includes servo controls to control panning and tilting of the video capture device in response to the control command.

11. A device, comprising:
a motion platform to including a camera mounted thereon to generate an image of a virtual reality (VR) participant, the motion platform to move the camera in response to a control command;
a location tracker to determine location data received from a headset of the VR participant; and
a controller to position the motion platform such that the VR participant's location within the image is adjusted by the control command in response to physical changes of the headset as determined from the location data.

12. The device of claim 11, wherein the location data is received as location coordinates from the headset by the location tracker, the location coordinates are translated by the location tracker from virtual coordinates of the headset to a reference point of the camera to provide physical coordinates to the controller for movement of the motion platform.

13. The device of claim 11, wherein the location tracker further comprises an infrared sensor to detect an infrared beacon generated from an infrared emitter in the headset, wherein the location data from the location tracker provides an alignment parameter to the controller to center the headset within a field of view of the camera.

14. A method, comprising:
generating video stream images of a virtual reality (VR) participant;
receiving location data from a headset of the VR participant;
detecting physical changes of the headset from the location data; and
adjusting the VR participant's position within the video stream images based on the detected physical changes of the headset.

15. The method of claim 14, wherein adjusting the VR participant's position within the video stream images based on the detected physical changes of the headset further comprises:
selecting between a plurality of cameras for generating the video stream images of the virtual reality (VR) participant based on detecting physical changes of the headset.
